(19) United States
(12) Patent Application Publication
(10) Pub. No.: US 2019/0289068 A1
(43) Pub. Date: Sep. 19, 2019

(54) METHOD, APPARATUS AND SYSTEM FOR REALIZING COMMUNICATION BETWEEN BLOCKCHAINS

(71) Applicant: ZhongAn Information Technology Service Co., Ltd., Shenzhen (CN)

(72) Inventors: Huanyu MA, Shenzhen (CN); Xuefeng LI, Shenzhen (CN); Xiaochuan WU, Shenzhen (CN)

(21) Appl. No.: 16/432,816

(22) Filed: Jun. 5, 2019

Related U.S. Application Data
(63) Continuation of application No. PCT/CN2018/090190, filed on Jun. 7, 2018.

(30) Foreign Application Priority Data
Jun. 7, 2017 (CN) 201710423247.8

(51) Int. Cl. H04L 29/08; H04L 29/06

(52) U.S. Cl. CPC H04L 67/108; H04L 69/22

(57) ABSTRACT

The present invention provides a method, an apparatus and a system for realizing communication between blockchains, and the method comprises: receiving a first communication packet sent by a first blockchain, the first communication packet comprising a first transaction, and the first transaction corresponding to a change of a database state on the first blockchain; generating a second communication packet according to the first communication packet; and sending the second communication packet to a second blockchain. In the present invention, the communication between a first blockchain and a second blockchain is realized by receiving a first communication packet including a transaction sent by the first blockchain, generating a second communication packet according to the first communication packet and sending the second communication packet to the second blockchain, and thus the transaction processing capability of a blockchain is improved.

### CROSS-REFERENCE TO RELATED APPLICATIONS

This application is a continuation of International Application No. PCT/CN2018/090190 filed on Jun. 7, 2018, which claims priority to Chinese patent application No. 201710423247.8 filed on Jun. 7, 2017. Both applications are incorporated herein in their entireties by reference.

### TECHNICAL FIELD

The present invention relates to the field of blockchain technologies, and in particular to a method, an apparatus and a system for realizing communication between blockchains.

### BACKGROUND

A blockchain in a narrow sense is a chained data structure, which is composed of data blocks sequentially connected in a chronological order, and is a non-tamperable and unforgeable distributed ledger guaranteed by cryptography. A blockchain in a broad sense refers to a new distributed infrastructure and computing paradigm, which verifies and stores data by using a block chain data structure, generates and updates data by using a distributed node consensus algorithm, ensures the security of data transmission and access by using cryptography, and programs and manipulates data with smart contracts consisted of automated script code. Blockchain technology collectively maintains a reliable database in a way of decentralization and de-trusting to solve the trust and security issues of a transaction.

The blockchain technology is not a single technology, but a result of the integration of multiple technologies. These technologies are combined together with a new structure to form a new way of data recording, data storage and data representation, which mainly relate to the following four technologies:

1, Distributed ledger. That is, a transaction accounting is done by multiple nodes distributed in different places, each of the nodes records a complete account, and thus the multiple nodes can all participate in supervising the legality of a transaction, and can also testify for it together. Unlike traditional centralized accounting schemes, no single node can record an account separately, and thus avoiding the possibility of a single biller being controlled or being bribed to record a false account. On the other hand, since there are enough accounting nodes, in theory, unless all nodes are destroyed, the account may not be lost, and thus the security of the account data is ensured.

2, Asymmetric encryption and authorization technology. Although a transaction information stored on a blockchain is public, an account identity information is highly encrypted and may be accessed only in case of getting the authorization of a data owner, and thus ensuring data security and personal privacy.

3, Consensus mechanism. That is, how to reach a consensus among all accounting nodes to determine the validity of a record is both a means of identification and a means of preventing tampering.

4, Smart contracts. Smart contracts are based on trusted and non-tamperable data that can automatically execute some predefined rules and terms.

At present, the network attribute of the blockchain is only developed to the extent similar to local area network.

### SUMMARY

In view of this, embodiments of the present invention provide a method, an apparatus and a system for realizing communication between blockchains, which can realize the communication between different blockchains, and thus the transaction processing capability of a blockchain is improved.

According to a first aspect of the embodiments in the present invention, a method for realizing communication between blockchains is provided, which includes: receiving a first communication packet sent by a first blockchain, the first communication packet including a first transaction, and the first transaction corresponding to a change of a database state on the first blockchain; generating a second communication packet according to the first communication packet; and sending the second communication packet to a second blockchain.

In some embodiments of the present invention, the sending the second communication packet to a second blockchain includes: sending the second communication packet to the second blockchain according to a routing table.

In some embodiments of the present invention, the sending the second communication packet to the second blockchain according to a routing table includes: sending the second communication packet to the second blockchain according to a dynamic routing table.

In some embodiments of the present invention, the method of the first aspect is performed by a chain router, the chain router is a third blockchain, the third blockchain is connected between the first blockchain and the second blockchain and is configured to receive and forward a communication packet, and the second communication packet includes a second transaction. The generating a second communication packet according to the first communication packet includes: generating the second transaction according to the first transaction, and writing the second transaction into the third blockchain. The first transaction includes a message content and a chain identifier of the second blockchain, and the second transaction includes the message content, the chain identifier of the second blockchain and a chain identifier of the first blockchain.

In some embodiments of the present invention, the generating the second transaction according to the first transaction includes: verifying whether the first transaction is from the first blockchain and obtaining a verification result; and generating the second transaction according to the first transaction, when the verification result is yes.

In some embodiments of the present invention, the verifying whether the first transaction is from the first blockchain and obtaining a verification result includes: verifying whether the first transaction is from the first blockchain by using a voting-based consensus algorithm and obtaining the verification result.

In some embodiments of the present invention, the chain router has several blocks that increase with an increase of transactions in the chain router, and each of the blocks includes a block header portion and a data portion.

In some embodiments of the present invention, the block header portion includes at least one of a chain identifier, a block height, a time, a hash value of a world state, a hash value of a block header portion of a last block adjacent to the block, parts of the last block adjacent to the block, validators hash values and a hash value of the data part, and the data portion at least includes all transactions within the block.

According to a second aspect of the embodiments in the present invention, a method for realizing communication between blockchains is provided, which includes: generating a first transaction and writing the first transaction into a first blockchain, the first transaction corresponding to a change of a database state on the first blockchain; and sending a first communication packet to the chain router. The chain router is a third blockchain, the first communication packet includes the first transaction so that the third blockchain generates a second communication packet according to the first communication packet and sends the second communication packet to the second blockchain.

In some embodiments of the present invention, the method of the second aspect is performed by the first blockchain, and the first transaction includes a message content and a chain identifier of the second blockchain.

According to a third aspect of the embodiments in the present invention, a method for realizing communication between blockchains is provided, which includes: receiving a second communication packet sent by a chain router, wherein the second communication packet is generated by the chain router according to a first transaction sent by a first blockchain, the chain router is a third blockchain, and the first transaction is corresponding to a change of a database state on the first blockchain; and generating a third transaction according to the second communication packet and writing the third transaction into a second blockchain.

In some embodiments of the present invention, the method of the third aspect is performed by the second blockchain, and the third transaction includes a message content and a chain identifier of the first blockchain.

According to a forth aspect of the embodiments in the present invention, an apparatus for realizing communication between blockchains is provided, which includes: a processor; and a memory for storing instructions executable by the processor. The processor is configured to: receive a first communication packet sent by a first blockchain, the first communication packet including a first transaction, and the first transaction corresponding to a change of a database state on the first blockchain; generate a second communication packet according to the first communication packet; and send the second communication packet to a second blockchain.

In some embodiments of the present invention, the processor is configured to send the second communication packet to the second blockchain according to a routing table. In some embodiments of the present invention, the processor is configured to send the second communication packet to the second blockchain according to a dynamic routing table.

In some embodiments of the present invention, the apparatus of the forth aspect is a chain router, the chain router is a third blockchain, the third blockchain is connected between the first blockchain and the second blockchain and is configured to receive and forward a communication packet, and the second communication packet includes a second transaction. The processor is configured to generate the second transaction according to the first transaction. The processor is further configured to write the second transaction into the third blockchain. The first transaction includes a message content and a chain identifier of the second blockchain, and the second transaction includes the message content, the chain identifier of the second blockchain and a chain identifier of the first blockchain.

In some embodiments of the present invention, the processor is further configured to verify whether the first transaction is from the first blockchain and obtain a verification result. The processor is configured to generate the second transaction according to the first transaction when the verification result is yes.

In some embodiments of the present invention, the processor is configured to verify whether the first transaction is from the first blockchain by using a voting-based consensus algorithm and obtain the verification result.

In some embodiments of the present invention, the chain router has several blocks that increase with an increase of transactions in the chain router, and each of the blocks includes a block header portion and a data portion.

In some embodiments of the present invention, the block header portion includes at least one of a chain identifier, a block height, a time, a hash value of a world state, a hash value of a block header portion of a last block adjacent to the block, parts of the last block adjacent to the block, validators hash values and a hash value of the data part, and the data portion at least includes all transactions within the block.

According to a fifth aspect of the embodiments in the present invention, an apparatus for realizing communication between blockchains is provided, which includes: a processor; and a memory for storing instructions executable by the processor. The processor is configured to: generate a first transaction and write the first transaction into a first blockchain, the first transaction corresponding to a change of a database state on the first blockchain; and send a first communication packet to the chain router. The chain router is a third blockchain, the first communication packet includes the first transaction so that the third blockchain generates a second communication packet according to the first communication packet and sends the second communication packet to the second blockchain.

In some embodiments of the present invention, the apparatus of the fifth aspect is the first blockchain, and the first transaction includes a message content and a chain identifier of the second blockchain.

According to a sixth aspect of the embodiments in the present invention, an apparatus for realizing communication between blockchains is provided, which includes: a processor; and a memory for storing instructions executable by the processor. The processor is configured to: receive a second communication packet sent by a chain router, wherein the second communication packet is generated by the chain router according to a first transaction sent by a first blockchain, the chain router is a third blockchain, and the first transaction is corresponding to a change of a database state on the first blockchain; and generate a third transaction according to the second communication packet and write the third transaction into a second blockchain.

In some embodiments of the present invention, the apparatus of the sixth aspect is the second blockchain, and the third transaction includes a message content and a chain identifier of the first blockchain.

According to a seventh aspect of the embodiments in the present invention, a system for realizing communication between blockchains is provided, which includes: a plurality of blockchains; and at least one chain router, wherein each of the at least one chain router is the chain router according to the forth aspect, the at least one chain router is connected between the plurality of blockchains, and is configured to receive and forward communication packets to realize communications between the plurality of blockchains.

In some embodiments of the present invention, the at least one chain router includes a plurality of chain routers, and each of the at least one chain router is a blockchain.

In some embodiments of the present invention, the plurality of chain routers are distributed in a tree structure or a mesh structure.

In some embodiments of the present invention, the plurality of chain routers are distributed in a form of a combination of a tree structure and a mesh structure.

In the embodiments of the present invention, a method, an apparatus and a system for realizing communication between blockchains are provided. The communication between a first blockchain and a second blockchain is realized by receiving a first communication packet including a transaction sent by the first blockchain, generating a second communication packet according to the first communication packet and sending the second communication packet to the second blockchain, and thus the transaction processing capability of a blockchain is improved.

### BRIEF DESCRIPTION OF DRAWINGS

FIG. 1 is a flowchart illustrating a method for realizing communication between blockchains according to an embodiment of the present invention.

FIG. 2 is a schematic flowchart illustrating a delegated stake-practical byzantine fault tolerance algorithm according to a chain router of the present invention in one embodiment.

FIG. 3 is a schematic structural diagram illustrating a block of a chain router according to an embodiment of the present invention.

FIG. 4 is a schematic structural diagram illustrating a chain router according to an embodiment of the present invention.

FIG. 5 is a flowchart illustrating a method for realizing communication between blockchains according to another embodiment of the present invention.

FIG. 6 is a flowchart illustrating a method for realizing communication between blockchains according to another embodiment of the present invention.

FIG. 7 is a flowchart illustrating a method for realizing communication between blockchains according to another embodiment of the present invention.

FIG. 8 is a schematic structural diagram illustrating an apparatus for realizing communication between blockchains according to an embodiment of the present invention.

FIG. 9 is a schematic structural diagram illustrating an apparatus for realizing communication between blockchains according to another embodiment of the present invention.

FIG. 10 is a schematic structural diagram illustrating an apparatus for realizing communication between blockchains according to another embodiment of the present invention.

FIG. 11 is a block diagram illustrating a computer apparatus for realizing communication between blockchains according to an exemplary embodiment of the present invention.

### DETAILED DESCRIPTION

A clear and complete description of technical solutions in the embodiments of the present invention will be given below, in combination with the accompanying drawings in the embodiments of the present invention. It is obvious that the embodiments described below are a part, rather than all, of the embodiments of the present invention. All other embodiments obtained by those skilled in the art according to the embodiments of the present invention without creative efforts shall fall within the protection scope of the present invention.

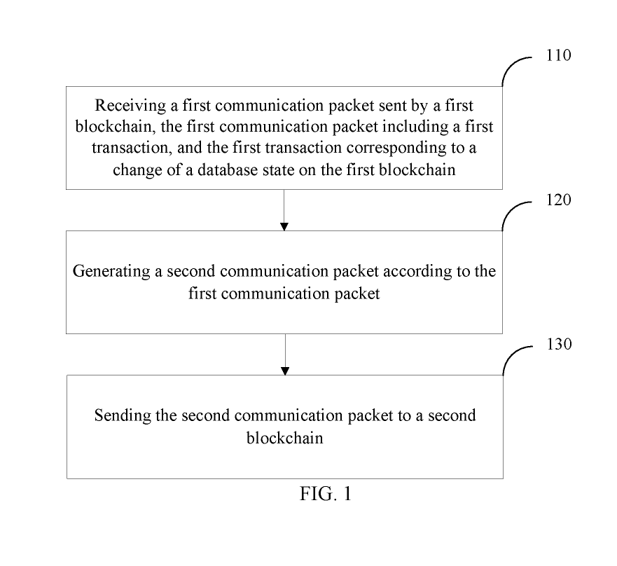

FIG. 1 is a flowchart illustrating a method for realizing communication between blockchains according to an embodiment of the present invention. The method of FIG. 1 may be performed, for example, by a chain router, as shown in FIG. 1, and the method includes the following contents.

110: receiving a first communication packet sent by a first blockchain, the first communication packet including a first transaction, and the first transaction corresponding to a change of a database state on the first blockchain.

The communication between the first blockchain and a second blockchain may be realized by connecting the chain router connected with the first blockchain and the second blockchain that cannot implement the forwarding of a communication packet.

Specifically, the chain router, like a router, can accept different blockchains through a communication protocol, so that different blockchains can communicate with each other. The communication protocol may be a set of communication protocols between blockchains and established according to the chain router, and a blockchain system complying with this set of protocols can access the chain router easily.

Some existing blockchains, such as Bitcoin, Ethereum, etc., exist prior to the chain router, and at the beginning of design, these existing blockchains do not have the function of communicating with other blockchains. For a blockchain system that exists prior to the chain router, without changing its own design, an adaptation system can be additionally designed to assist the communication between the blockchains and the chain router. According to an embodiment of the present invention, the first blockchain and the second blockchain may be understood as a blockchain in a broad sense, that is, an architecture including a blockchain data structure, implemented based on blockchain technology and having the function of maintaining a blockchain database. The architecture includes a corresponding computing paradigm that may be implemented on a computer.

Specifically, when communication is required between the first blockchain and the second blockchain, the chain router may receive the first communication packet sent by the first blockchain, and the first communication packet includes the first transaction. The first transaction may include a message to be sent by the first blockchain to the second blockchain. The message may be an instruction, for example, the first blockchain commands the second blockchain to perform a certain action, or to store a certain data on the second blockchain.

Further, the first communication packet may also include verification information, and the chain router can ensure the security of the communication process by verifying whether the first communication packet is secure and trusted, i.e., whether it is from a trusted first blockchain, through the verification information.

Specifically, the first transaction may be stored in the database of the first blockchain by the first blockchain, that is, the first transaction is corresponding to the change of the database state on the first blockchain. In this way, each time a communication packet is sent by the first blockchain, the transaction in the communication packet can be stored in the database to realize the traceability of data.

120: generating a second communication packet according to the first communication packet.

Specifically, the second communication packet includes the message in the first transaction to be sent by the first blockchain to the second blockchain.

130: sending the second communication packet to a second blockchain.

Specifically, the chain router may be connected with multiple blockchains, the information of the second blockchain may be included in the first communication packet, such as an IP address and/or a chain identifier, etc., thus enabling the chain router to obtain the information of the second blockchain and send the second communication packet to the second blockchain. Similarly, the information of the second blockchain may also be included in the second communication packet to enable the second blockchain to identify and receive the second communication packet. Further, the first communication packet and/or the second communication packet may further include the information of the first blockchain, such as an IP address and/or a chain identifier, etc., for indicating the source of the communication packet.

The processing capability of a blockchain system to transactions may be enhanced and the horizontal expansion of the blockchain transaction capability may be realized by connecting multiple blockchains through the chain router. For example, the first blockchain may be responsible for transaction of advertising business, the second blockchain may be responsible for transaction of taxi business, so that the transactions are distributed on two blockchains, which can alleviate the burden of one blockchain taking on all transactions. In addition, communication barriers between blockchains can be opened by the chain router to achieve interconnection and mutual trust between blockchains.

In the embodiments of the present invention, a method for realizing communication between blockchains is provided. The communication between a first blockchain and a second blockchain is realized by receiving a first communication packet including a transaction sent by the first blockchain, generating a second communication packet according to the first communication packet and sending the second communication packet to the second blockchain, and thus the transaction processing capability of a blockchain is improved.

According to the embodiments of the present invention, in step 130, the second communication packet may be sent to the second blockchain by the chain router according to a routing table.

Specifically, the routing table may be stored in the chain router, the routing table includes routing information of each blockchain connected to the chain router, so that the second communication packet can be sent to the second blockchain by the chain router according to the routing information. For example, the first communication packet includes a chain identifier of the second blockchain, after receiving the first communication packet, the second communication packet may be sent to the second blockchain by the chain router according to the routing information in the routing table corresponding to the chain identifier of the second blockchain.

According to the embodiments of the present invention, the second communication packet may be sent to the second blockchain by the chain router according to a dynamic routing table.

Specifically, the routing table in the chain router may be updated in real time according to the change of each blockchain connected to the chain router to ensure the accuracy and high efficiency of the communication process.

According to the embodiments of the present invention, the chain router is a third blockchain, the third blockchain is connected between the first blockchain and the second blockchain and is configured to receive and forward a communication packets, and the second communication packet includes a second transaction. The generating a second communication packet according to the first communication packet includes: generating the second transaction according to the first transaction, and writing the second transaction into the third blockchain. The first transaction includes a message content and a chain identifier of the second blockchain, and the second transaction includes the message content, the chain identifier of the second blockchain and a chain identifier of the first blockchain.

According to an embodiment of the present invention, the chain router may be a blockchain, which facilitates the chain router to record each communication completed by the chain router, and thereby improving the security of the communication. For example, the chain router is a third blockchain, and a second transaction is generated by the third blockchain according to the first transaction in the first communication packet and is written into the third blockchain. The second transaction may include the message content, the chain identifier of the second blockchain and a chain identifier of the first blockchain, which ensures that the complete communication information is recorded and facilitates the traceability process.

According to the embodiments of the present invention, the chain router may verify whether the first transaction is from the first blockchain and obtain a verification result; and when the verification result is yes, the second transaction is generated according to the first transaction.

Specifically, the chain router may verify whether the first transaction is from the first blockchain. When the verification result is yes, the second transaction is generated according to the first transaction, and then the second communication packet is generated. When the verification result is no, the operation is terminated, or a feedback message is sent to the first blockchain. Thus whether the first transaction has been tampered with can be verified, which can further improve the security of the communication process.

According to an embodiment of the present invention, the chain router has several blocks that increase with an increase of transactions in the chain router. Of course, the transactions in the chain router may include a second transaction for communication, and may also include transactions for other purposes, which is not limited by the present invention.

According to the embodiments of the present invention, a voting-based consensus algorithm may be used by the chain router to verify whether the first transaction is from the first blockchain and obtain the verification result. For example, the voting-based consensus algorithm may be a delegated stake-practical byzantine fault tolerance consensus algorithm.

Specifically, since the chain router itself is a blockchain, it usually has several nodes. In theory, a blockchain with a node can be operated normally, but in fact, the function of distributed ledger and byzantine fault tolerance consensus algorithm can only be reflected on multiple nodes. In the consensus algorithm used, the recommended number of nodes is at least 4.

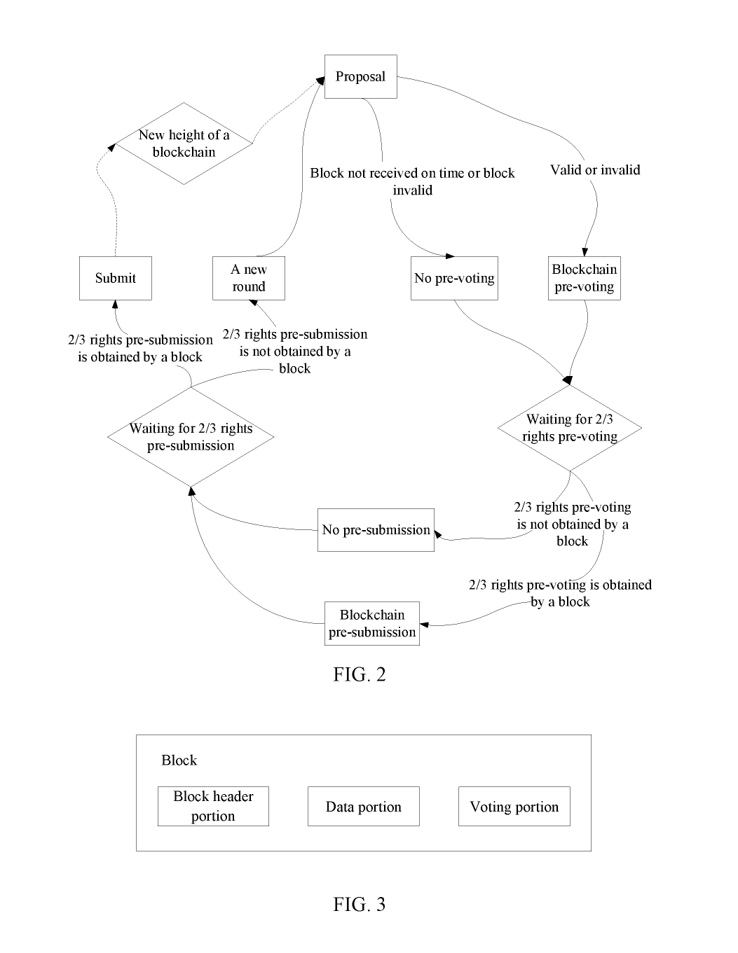

FIG. 2 is a schematic flowchart illustrating a delegated stake-practical byzantine fault tolerance algorithm according to a chain router of the present invention in one embodiment. As shown in FIG. 2, the Delegated Stake-Practical Byzantine Fault Tolerance (DS-PBFT) algorithm of the chain router under this embodiment is similar in process to that of the PBFT algorithm.

A transaction received from a sub chain (i.e. the first transaction) is verified by the chain router using the Delegated Stake-Practical Byzantine Fault Tolerance algorithm, and the design ideas are as the following content.

The Proof of Work (PoW) algorithm is a Byzantine Fault Tolerance (BFT) consensus algorithm that is applied to bitcoin and Ethereum. Since the issue of bitcoin, the reliability of the Proof of Work algorithm has been proved, but its waste of resources is also obvious to all. The Proof of Stake (PoS) algorithm is a consensus algorithm proposed to solve the problem of resource waste of the Proof of Work algorithm. The integrity of the voters is ensured through replacing the calculation power of miners' contributions to mining by the proportion of voters' rights in the voting rights pool and in conjunction with an appropriate punishment mechanism. However, there is still a big difference between calculation power and rights, and the most important difference is that the calculation power cannot be dispersed. A miner with a fixed calculation power cannot mine in two chains at the same time and keep the total calculation power doubled, but a voter with a certain rights can vote for every possible block, which can guarantee that its rights will not be damaged, as long as any block becomes a winner in the future. However, there is a big security risk in doing so, because it greatly reduces the cost of doing evil for the perpetrators.

As a commonly used efficient consensus algorithm, Raft's biggest drawback is that it cannot prevent byzantine nodes. A byzantine leader node with a powerful network configuration will bring a devastating blow to the consensus of Raft algorithm. In the development of the byzantine fault tolerance consensus algorithm, some algorithms combining Raft and BFT have been proposed. Taking Practical Byzantine Fault Tolerance (PBFT) algorithm as an example, some reliable nodes are called validators, and a validator has the opportunity to be a leader. In each round of blockchain generation process, there is a new validator to be the leader of the round by default. The leader is responsible for packaging the new block, and broadcasting a block, which is considered as reasonable by the leader itself, to all validators. Consensus will be reached about the new block only after two rounds of voting and confirmation by more than ⅔ of all the validators. This consensus approach greatly increases the speed of the generation of block, and as long as less than ⅓ of the validators are guaranteed to be not byzantine nodes, blocks can be continuously generated.

It is undeniable that the byzantine node fault tolerance algorithm used in PBFT is reliable for guaranteeing the security of the network of byzantine nodes below ⅓. However, in practical applications, especially when it comes to economic interests, even if the validator is a selected reliable node, the inventor considered we cannot simply rely on the security of ⅓ without a punishment mechanism, and to ensure safety, the reward and punishment must be carried out quickly, and thus the purpose of encouragement and vigilance may be realized respectively. The reward and punishment must be directly related to economic interests. Therefore, the inventor modified the original consensus mechanism so that the weight of the vote of the validator corresponds to the rights of the token mortgaged by the validator on the chain. As a result, the mechanism that more than two-thirds of the voters are required to generate blocks is modified to more than two-thirds of the total rights. In addition, in the PBFT consensus algorithm, ordinary nodes only synchronize a new block sent from the leader node and do not participate in the consensus, resulting in that the security of its consensus algorithm depends only on the number of verification nodes, and the increase in the number of ordinary nodes cannot improve the security of byzantine fault tolerance. The participation of non-verified nodes is added in the new consensus mechanism. A verification node corresponds to a validator account, and non-validators may earn their own interests by entrusting the rights to the validators and the proxy votes of the validators. Because of interests, non-validators will carefully choose the proxy validators, so that all people are involved in the consensus without the efficiency reduction caused by the all nodes participating in the consensus. Such a consensus algorithm is called a Delegated Stake-Practical Byzantine Fault Tolerance (DS-PBFT) algorithm by the inventor.

In the above solution, the chain router uses the Delegated Stake-Practical Byzantine Fault Tolerance algorithm realized by the vote of the validators as the consensus algorithm, so that all nodes are involved in the consensus of the chain router without the efficiency reduction caused by the all nodes participating in the consensus.

Similarly, the sub-chain may also use the Delegated Stake-Practical Byzantine Fault Tolerance algorithm to verify a transaction (i.e., the second transaction) received from the chain router.

Optionally, as another embodiment, each block in the third blockchain includes a block header portion (Header) and a data portion (Data).

Specifically, the chain router has an increasing number of blocks, each of which may include a number of transactions, and these blocks may be arranged in chronological order. In order to facilitate marking and distinguishing each of the blocks, the block header portion of each block may include the generation time, the location of the block, and verification information when the block is generated.

In addition, since the chain router itself is also a blockchain, its status information may be saved and updated in the form of blocks, and the status information may usually also be included in a database. According to an embodiment of the present invention, the block header portion includes: at least one of a chain identifier (Chain ID), a block height (Hight), a time (Time), a hash value of a world state (App Hash), a hash value of a block header portion of a last block adjacent to the block (Last Header Hash), parts of the last block adjacent to the block (Last Block Parts), validators hash values (Validators Hash) and a hash value of the data part (Data Hash), and the data portion at least includes all transactions within the block.

FIG. 3 is a schematic structural diagram illustrating a block of a chain router according to an embodiment of the present invention. As shown in FIG. 3, each block in the third blockchain may further include a voting portion (Last Commit). The voting portion may be used to establish a chain router between the block and the previous block. For example, the consensus of a block requires two rounds of voting by more than ⅔ verification node rights. Votes of all the ⅔ verification node (Commit) in the second round will be temporarily saved, and will be placed in the voting portion (Last Commit) of a next block when the next block is proposed. Thus a voting portion of a block includes votes of more than ⅔ validators in the last round of voting.

Specifically, the block header portion includes: the chain identifier (Chain ID), the block height (Hight), the time (Time), the hash value of a world state (App Hash), the hash value of a block header portion of a last block adjacent to the block (Last Header Hash), the parts of the last block adjacent to the block (Last Block Parts), the validators hash values (Validators Hash), the hash value of the data part (Data Hash) and a hash value of the voting part (Last Commit Hash). Among them, the latter two parts are the inspection of the integrity of this block. The data portion includes all transactions within the block. A transaction refers to a change in the state of the database.

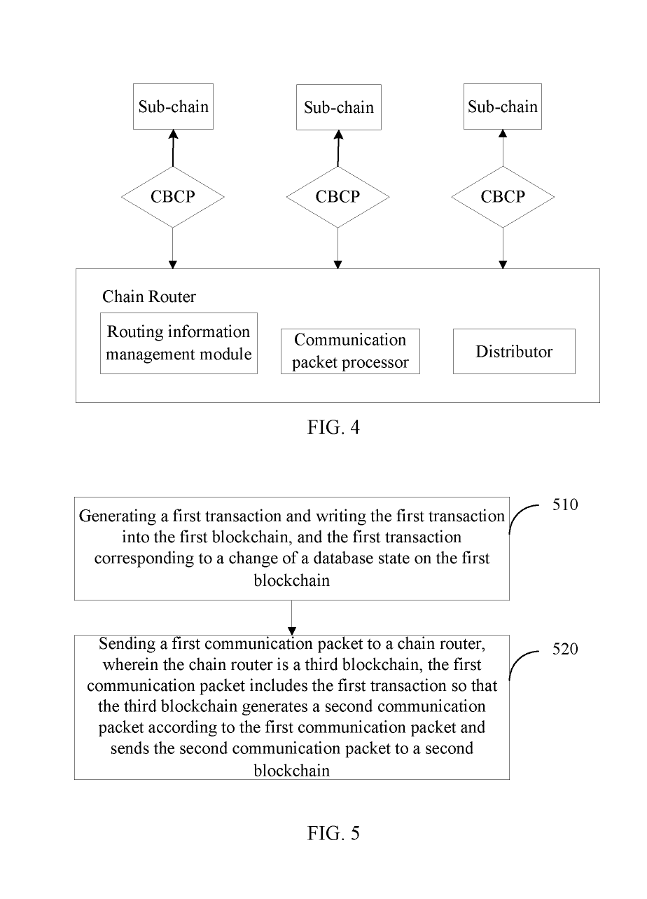

FIG. 4 is a schematic structural diagram illustrating a chain router according to an embodiment of the present invention. As shown in FIG. 4, the chain router may be connected to multiple sub-chains through a Cross Blockchain Communication Protocol (CBCP). In this embodiment, the chain router includes a routing information management module, a communication packet processor and a distributor. A routing table is stored in the routing information management module, the communication packet processor may parse a received first communication packet and generate a second communication packet, and the distributor forwards the second communication packet according to the routing table. The routing table may be a dynamically updated routing table.

FIG. 5 is a flowchart illustrating a method for realizing communication between blockchains according to another embodiment of the present invention. The method in FIG. 5 is performed by a first blockchain, in which the specific process may be referred to the description in FIG. 1. As shown in FIG. 5, the method includes the following contents.

510: generating a first transaction and writing the first transaction into the first blockchain, and the first transaction corresponding to a change of a database state on the first blockchain.

520: sending a first communication packet to a chain router, wherein the chain router is a third blockchain, the first communication packet includes the first transaction so that the third blockchain generates a second communication packet according to the first communication packet and sends the second communication packet to a second blockchain.

Optionally, as another embodiment, the first transaction includes a message content and a chain identifier of the second blockchain.

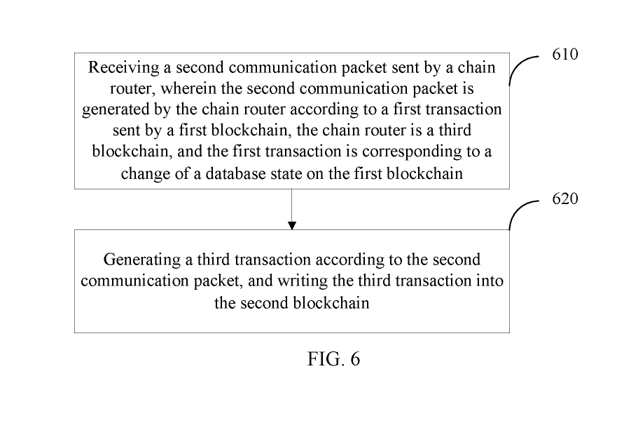

FIG. 6 is a flowchart illustrating a method for realizing communication between blockchains according to another embodiment of the present invention. The method in FIG. 6 is performed by a second blockchain, in which the specific process may be referred to the description in FIG. 1. As shown in FIG. 6, the method includes the following contents.

610: receiving a second communication packet sent by a chain router, wherein the second communication packet is generated by the chain router according to a first transaction sent by a first blockchain, the chain router is a third blockchain, and the first transaction is corresponding to a change of a database state on the first blockchain.

620: generating a third transaction according to the second communication packet, and writing the third transaction into the second blockchain.

Specifically, the third transaction may be generated when the second communication packet is received and the second transaction is processed by the second blockchain. The third transaction may include a message content, a chain identifier of the first blockchain, and a chain identifier of the second blockchain. The third transaction may be written into the second blockchain by the second blockchain to realize the traceability of data.

The information transmission process and state maintenance of the chain router and the system for realizing communication between blockchains in this embodiment will be further described below.

(1) Information Transmission Process

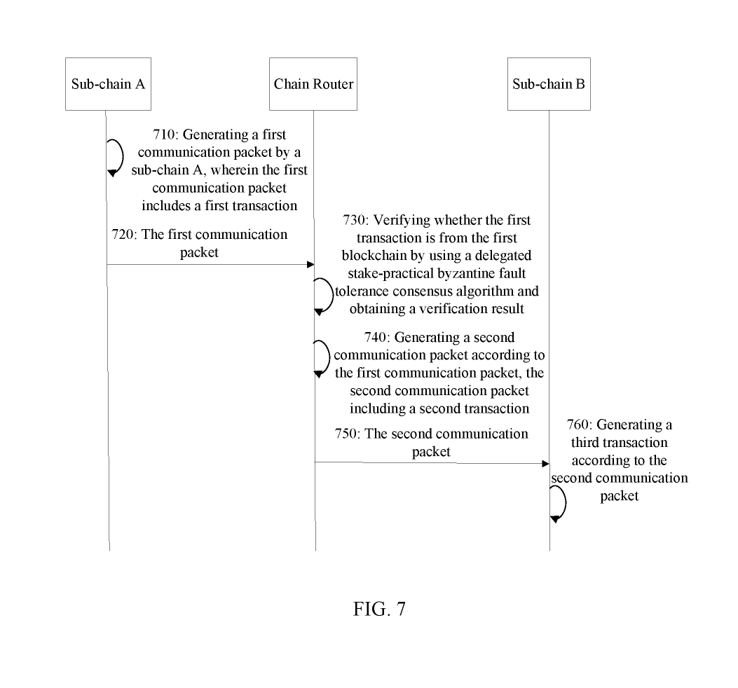

FIG. 7 is a flowchart illustrating a method for realizing communication between blockchains according to another embodiment of the present invention. The method in FIG. 7 is an example of FIG. 1, FIG. 5 and FIG. 6, and a detailed description is omitted as appropriate. As shown in FIG. 7, the method includes the following contents.

710: generating a first communication packet by a sub-chain A, wherein the first communication packet includes a first transaction.

Supposing the sub-chain A is required to send a message M to a sub-chain B, the following first transaction is written into the blockchain by the sub-chain A through consensus.

[Message Content: M, Message Receiving Chain: B]

720: sending the first communication packet to a chain router by the sub-chain A.

730: verifying whether the first transaction is from the first blockchain by the chain router using a delegated stake-practical byzantine fault tolerance consensus algorithm and obtaining a verification result.

When the verification result is no, the operation process is terminated.

740: generating a second communication packet by the chain router according to the first communication packet, when the verification result is yes, wherein the second communication packet includes a second transaction.

The second transaction is written into the blockchain by the chain router after the following second transaction is generated. [Message Content: M, Message Receiving Chain: B, Message Sending Chain: A]

750: sending the second communication packet to the sub-chain B by the chain router according to a dynamic routing table.

760: generating a third transaction by the sub-chain B according to the second communication packet.

The third transaction is written into the blockchain by the sub-chain B after the following third transaction is generated.

[Message Content: M, Message Source: A]

(2) State Maintenance

As a bridge between different sub-chains, the chain router is responsible for maintaining some states about the sub-chains.

First, if a sub-chain is required to communicate with the chain router, it may be registered on the chain router, which includes a Chain ID of the sub-chain, the information of verification nodes on the sub-chain, the type of the asset on the sub-chain, and so on. In this way, the chain router is assisted to parse out the corresponding sub-chain when receiving the communication request, and complete the forwarding operation.

Secondly, the chain router is required to receive the latest block information of a sub-chain in real time and the voting (Commit) for the latest block to realize the maintaining for the basic state of the sub-chain and verify transactions sent from the sub-chain and so on.

In addition, because the identity of a verification node is changed in real time, the chain router is required to maintain the dynamic verification nodes information on all the sub-chains to verify whether a transaction from a sub-chain is legal.

Similarly, a sub-chain is also required to maintain the corresponding information on the chain router to determine that a transaction is indeed sent by the chain router, which includes an identity of the chain router, the information of verification nodes on the chain router, the latest block and voting on the chain router and so on.

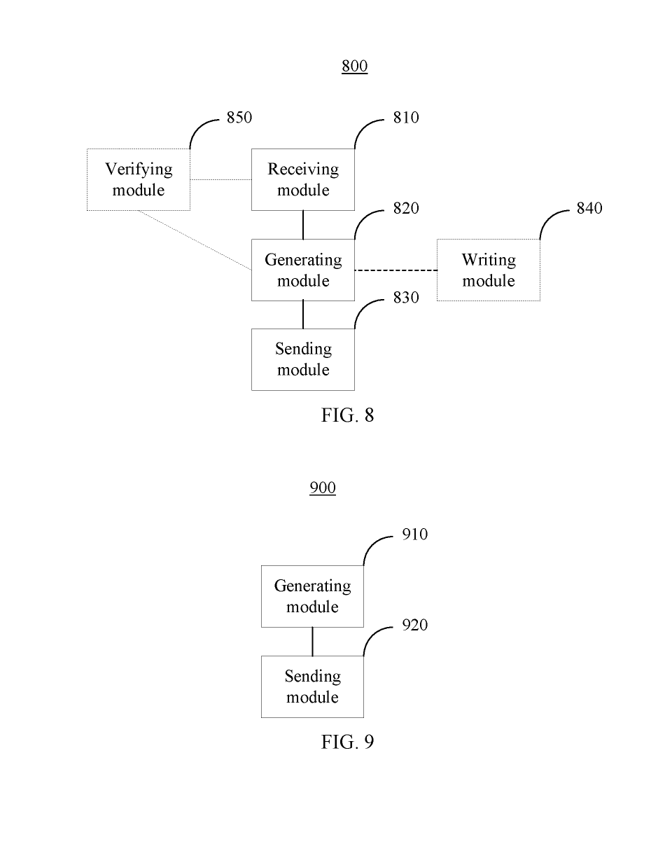

FIG. 8 is a schematic structural diagram illustrating an apparatus for realizing communication between blockchains according to an embodiment of the present invention. As shown in FIG. 8, the apparatus 800 includes: a receiving module 810 configured to receive a first communication packet sent by a first blockchain, the first communication packet including a first transaction, and the first transaction corresponding to a change of a database state on the first blockchain; a generating module 820 configured to generate a second communication packet according to the first communication packet; and a sending module 830 configured to send the second communication packet to a second blockchain.

In the embodiments of the present invention, an apparatus for realizing communication between blockchains is provided. The communication between a first blockchain and a second blockchain is realized by receiving a first communication packet including a transaction sent by the first blockchain, generating a second communication packet according to the first communication packet and sending the second communication packet to the second blockchain, and thus the transaction processing capability of a blockchain is improved.

Optionally, as another embodiment, the sending module 830 is configured to send the second communication packet to the second blockchain according to a routing table.

Optionally, as another embodiment, the sending module 830 is configured to send the second communication packet to the second blockchain according to a dynamic routing table.

Optionally, as another embodiment, the apparatus 800 is a chain router, the chain router is a third blockchain, the third blockchain is connected between the first blockchain and the second blockchain and is configured to receive and forward a communication packets, and the second communication packet includes a second transaction. The generating module is configured to generate the second transaction according to the first transaction. The apparatus 800 further includes: a writing module 840 configured to write the second transaction into the third blockchain. The first transaction includes a message content and a chain identifier of the second blockchain, and the second transaction includes the message content, the chain identifier of the second blockchain and a chain identifier of the first blockchain.

Optionally, as another embodiment, the apparatus 800 further includes: a verifying module 850 configured to verify whether the first transaction is from the first blockchain and obtain a verification result. The generating module 820 is configured to generate the second transaction according to the first transaction, when the verification result is yes.

Optionally, as another embodiment, the verifying module 850 is configured to verify whether the first transaction is from the first blockchain by using a voting-based consensus algorithm and obtain the verification result.

Optionally, as another embodiment, the chain router has several blocks that increase with an increase of transactions in the chain router, and each of the blocks includes a block header portion and a data portion.

Optionally, as another embodiment, the block header portion includes at least one of a chain identifiers, a block height, a time, a hash value of a world state, a hash value of a block header portion of a last block adjacent to the block, parts of the last block adjacent to the block, validators hash values and a hash value of the data part, and the data portion at least includes all transactions within the block.

For the operation and function of each module of the apparatus 800, reference may be made to the method in FIG. 1 above, and in order to avoid repetition, it will not be repeated here.

FIG. 9 is a schematic structural diagram illustrating an apparatus for realizing communication between blockchains according to another embodiment of the present invention. As shown in FIG. 9, the apparatus 900 includes: a generating module 910 configured to generate a first transaction and write the first transaction into a first blockchain, the first transaction corresponding to a change of a database state on the first blockchain; and a sending module 920 configured to send a first communication packet to the chain router. The chain router is a third blockchain, the first communication packet includes the first transaction so that the third blockchain generates a second communication packet according to the first communication packet and sends the second communication packet to the second blockchain.

Optionally, as another embodiment, the first transaction includes a message content and a chain identifier of the second blockchain.

For the operation and function of each module of the apparatus 900, reference may be made to the method of FIG. 1 and FIG. 6 above, and in order to avoid repetition, it will not be repeated here.

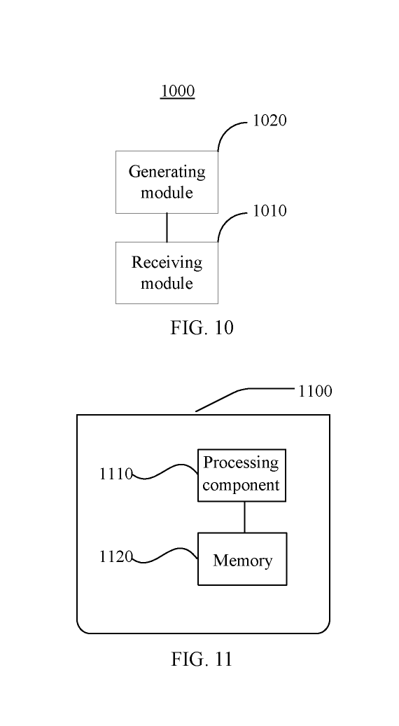

FIG. 10 is a schematic structural diagram illustrating an apparatus 1000 for realizing communication between blockchains according to another embodiment of the present invention. As shown in FIG. 10, the apparatus 1000 includes: a receiving module 1010 configured to receive a second communication packet sent by a chain router, wherein the second communication packet is generated by the chain router according to a first transaction sent by a first blockchain, the chain router is a third blockchain, and the first transaction is corresponding to a change of a database state on the first blockchain; and a generating module 1020 configured to generate a third transaction according to the second communication packet and write the third transaction into a second blockchain.

Optionally, as another embodiment, the third transaction includes a message content and a chain identifier of the first blockchain.

For the operation and function of each module of the apparatus 1000, reference may be made to the method of FIG. 1 and FIG. 7 above, and in order to avoid repetition, it will not be repeated here.

A system for realizing communication between blockchains is provided according to the embodiments of the present invention, which includes: a plurality of blockchains; and at least one chain router. Each of the at least one chain router is the chain router described in the FIG. 8, the at least one chain router is connected between the plurality of blockchains, and is configured to receive and forward communication packets to realize communications between the plurality of blockchains.

In some embodiments of the present invention, the at least one chain router includes a plurality of chain routers, and the each of the at least one chain router is a blockchain.

Specifically, each of the plurality of chain routers may be connected to multiple sub-chains, the chain router functions as a router, which realizes the analysis and forwarding of communication packets according to the communication protocol, and dynamically maintain the network topology of the system.

The final structure of the network of the chain router is affected by many factors. The most important factor is the number of blockchains that need to communicate. As the number of blockchains accessing to a chain network gradually increased, the number of blockchains connected to one chain router will continue to increase. When the number of blockchains is more than a load of the chain router, the number of the chain router may be increased to share the pressure.

In some embodiments of the present invention, the plurality of chain routers are distributed in a tree structure or a mesh structure.

Specifically, the tree structure means that the parent node of each node is a unique topology. The mesh structure means that the parent node of each node is not a unique topology, the topology forms a hierarchical structure, and its topological relationship corresponds to a hierarchical relationship.

For example, the plurality of chain routers described above include an upper chain and an underlying chain. The underlying chain is responsible for connecting the upper chain and is responsible for maintaining communication between the upper chain. That is, if target chains are in the same upper chain, then they communicate directly through the upper chain. If the target chains are not in the same upper chain, then they need to communicate through the underlying chain. The lowest layer constitutes the backbone of the chain routers. In practical applications, the number of layers of multiple chain routers may be set according to actual conditions, which is not limited by the present invention. In addition, a rule similar to Border Gateway Protocol (BGP) may be used in the uppermost chain routers, while a tree structure, a mesh structure, a tree and mesh structure may be used in each of the sub-domains below the uppermost chain routers. In some embodiments of the present invention, the plurality of chain routers are distributed in a form of a combination of a tree structure and a mesh structure.

FIG. 11 is a block diagram illustrating a computer apparatus 1100 for realizing communication between blockchains according to an exemplary embodiment of the present invention.

Referring to FIG. 11, the apparatus 1100 includes a processing component 1110 that further includes one or more processors, and memory resources represented by a memory 1120 for storing instructions executable by the processing component 1110, such as application programs. The application programs stored in the memory 1120 may include one or more modules each corresponding to a set of instructions. Further, the processing component 1110 is configured to execute the instructions to perform the above method for realizing communication between blockchains.

The apparatus 1100 may also include a power component configured to perform power management of the apparatus 1100, wired or wireless network interface(s) configured to connect the apparatus 1100 to a network, and an input/output (I/O) interface. The apparatus 1100 may be operated based on an operating system stored in the memory 1120, such as Windows Server™, Mac OS X™, Unix™, Linux™, FreeBSD™, or the like.

A non-transitory computer readable storage medium storing computer executable instructions that, when executed by a processor of the apparatus 1100 for realizing communication between blockchains, cause the apparatus 1100 to perform a method including: receiving a first communication packet sent by a first blockchain, the first communication packet including a first transaction, and the first transaction corresponding to a change of a database state on the first blockchain; generating a second communication packet according to the first communication packet; and sending the second communication packet to a second blockchain.

Persons skilled in the art may realize that, units and algorithm steps of examples described in combination with the embodiments disclosed here can be implemented by electronic hardware, computer software, or the combination of the two. Whether the functions are executed by hardware or software depends on particular applications and design constraint conditions of the technical solutions. Persons skilled in the art may use different methods to implement the described functions for each particular application, but it should not be considered that the implementation goes beyond the scope of the present invention.

It may be clearly understood by persons skilled in the art that, for the purpose of convenient and brief description, for a detailed working process of the foregoing system, apparatus and unit, reference may be made to the corresponding process in the method embodiments, and the details are not to be described here again.

In several embodiments provided in the present application, it should be understood that the disclosed system, apparatus, and method may be implemented in other ways. For example, the described apparatus embodiments are merely exemplary. For example, the unit division is merely logical functional division and may be other division in actual implementation. For example, multiple units or components may be combined or integrated into another system, or some features may be ignored or not performed.

Furthermore, the shown or discussed coupling or direct coupling or communication connection may be accomplished through indirect coupling or communication connection between some interfaces, apparatuses or units, or may be electrical, mechanical, or in other forms.

Units described as separate components may be or may not be physically separated. Components shown as units may be or may not be physical units, that is, may be integrated or may be distributed to a plurality of network units. Some or all of the units may be selected to achieve the objective of the solution of the embodiment according to actual demands.

In addition, the functional units in the embodiments of the present invention may either be integrated in a processing module, or each be a separate physical unit; alternatively, two or more of the units are integrated in one unit. The integrated units may be implemented through hardware or software functional units.

If implemented in the form of software functional units and sold or used as an independent product, the integrated units may also be stored in a computer readable storage medium. Based on such understanding, the technical solution of the present invention or the part that makes contributions to the prior art, or a part of the technical solution may be substantially embodied in the form of a software product. The computer software product is stored in a storage medium, and contains several instructions to instruct computer equipment (such as, a personal computer, a server, or network equipment) to perform all or a part of steps of the method described in the embodiments of the present invention. The storage medium includes various media capable of storing program codes, such as, a USB flash drive, a mobile hard disk, a Read-Only Memory (ROM), a Random Access Memory (RAM), a magnetic disk or an optical disk.

The foregoing descriptions are merely specific embodiments of the present invention, but the protection scope of the present invention is not limited hereto. Any equivalent modification or replacement easily thought of by persons skilled in the art within the technical scope of the present invention should be included within the protection scope of the present invention. Therefore, the protection scope of the present invention is subject to the appended claims.

What is claimed is:

1. A method for realizing communication between blockchains, comprising:
receiving a first communication packet sent by a first blockchain, the first communication packet comprising a first transaction, and the first transaction corresponding to a change of a database state on the first blockchain;
generating a second communication packet according to the first communication packet; and
sending the second communication packet to a second blockchain.

2. The method according to claim 1, wherein the sending the second communication packet to a second blockchain comprises:
sending the second communication packet to the second blockchain according to a routing table.

3. The method according to claim 2, wherein the sending the second communication packet to the second blockchain according to a routing table comprises:
sending the second communication packet to the second blockchain according to a dynamic routing table.

4. The method according to claim 1, wherein the method is performed by a chain router, the chain router is a third blockchain, the third blockchain is connected between the first blockchain and the second blockchain and is configured to receive and forward a communication packet, and the second communication packet comprises a second transaction,
wherein the generating a second communication packet according to the first communication packet comprises:
generating the second transaction according to the first transaction, and writing the second transaction into the third blockchain, wherein the first transaction comprises a message content and a chain identifier of the second blockchain, and the second transaction comprises the message content, the chain identifier of the second blockchain and a chain identifier of the first blockchain.

5. The method according to claim 4, wherein the generating the second transaction according to the first transaction comprises:
verifying whether the first transaction is from the first blockchain and obtaining a verification result; and
generating the second transaction according to the first transaction when the verification result is yes.

6. The method according to claim 5, wherein the verifying whether the first transaction is from the first blockchain and obtaining a verification result comprises:
verifying whether the first transaction is from the first blockchain by using a voting-based consensus algorithm and obtaining the verification result.

7. The method according to claim 4, wherein the chain router has several blocks that increase with an increase of transactions in the chain router, and each of the blocks comprises a block header portion and a data portion.

8. The method according to claim 7, wherein the block header portion comprises at least one of a chain identifier, a block height, a time, a hash value of a world state, a hash value of a block header portion of a last block adjacent to the block, parts of the last block adjacent to the block, validators hash values and a hash value of the data part, and the data portion at least comprises all transactions within the block.

9. A method for realizing communication between blockchains, comprising:
generating a first transaction and writing the first transaction into a first blockchain, the first transaction corresponding to a change of a database state on the first blockchain; and
sending a first communication packet to the chain router,
wherein the chain router is a third blockchain, the first communication packet comprises the first transaction so that the third blockchain generates a second communication packet according to the first communication packet and sends the second communication packet to a second blockchain.

10. The method according to claim 9, wherein the method is performed by the first blockchain, and the first transaction comprises a message content and a chain identifier of the second blockchain.

11. An apparatus for realizing communication between blockchains, comprising:
a processor; and
a memory for storing instructions executable by the processor;
wherein the processor is configured to:
receive a first communication packet sent by a first blockchain, the first communication packet comprising a first transaction, and the first transaction corresponding to a change of a database state on the first blockchain;
generate a second communication packet according to the first communication packet; and
send the second communication packet to a second blockchain.

12. The apparatus according to claim 11, wherein the processor is configured to send the second communication packet to the second blockchain according to a routing table.

13. The apparatus according to claim 12, wherein the processor is configured to send the second communication packet to the second blockchain according to a dynamic routing table.

14. The apparatus according to claim 11, wherein the apparatus is a chain router, the chain router is a third blockchain, the third blockchain is connected between the first blockchain and the second blockchain and is configured to receive and forward a communication packet, the second communication packet comprises a second transaction, and the processor is configured to generate the second transaction according to the first transaction;
and the processor is further configured to write the second transaction into the third blockchain, wherein the first transaction comprises a message content and a chain identifier of the second blockchain, and the second transaction comprises the message content, the chain identifier of the second blockchain and a chain identifier of the first blockchain.

15. The apparatus according to claim 14, wherein the processor is further configured to:
verify whether the first transaction is from the first blockchain and obtain a verification result,
wherein the processor is configured to generate the second transaction according to the first transaction when the verification result is yes.

16. The apparatus according to claim 15, wherein the processor is configured to verify whether the first transaction is from the first blockchain by using a voting-based consensus algorithm and obtain the verification result.

17. The apparatus according to claim 14, wherein the chain router has several blocks that increase with an increase of transactions in the chain router, and each of the blocks comprises a block header portion and a data portion.

18. The apparatus according to claim 17, wherein the block header portion comprises at least one of a chain identifier, a block height, a time, a hash value of a world state, a hash value of a block header portion of a last block adjacent to the block, parts of the last block adjacent to the block, validators hash values and a hash value of the data part, and the data portion at least comprises all transactions within the block.

19. A system for realizing communication between blockchains, comprising:
a plurality of blockchains; and
at least one chain router, wherein the at least one chain router is connected between the plurality of blockchains, and is configured to receive and forward communication packets to realize communications between the plurality of blockchains,
wherein each of the at least one chain router is configured to receive a first communication packet sent by a first blockchain, the first communication packet comprising a first transaction, and the first transaction corresponding to a change of a database state on the first blockchain, generate a second communication packet according to the first communication packet and send the second communication packet to a second blockchain,
wherein the chain router is a third blockchain, the third blockchain is connected between the first blockchain and the second blockchain and is configured to receive and forward a communication packet, the second communication packet comprises a second transaction, and the chain router is configured to generate the second transaction according to the first transaction, and write the second transaction into the third blockchain, wherein the first transaction comprises a message content and a chain identifier of the second blockchain, and the second transaction comprises the message content, the chain identifier of the second blockchain and a chain identifier of the first blockchain.

20. The system according to claim 19, wherein the at least one chain router comprises a plurality of chain routers, and each of the at least one chain router is a blockchain.
